(19) United States
(12) Patent Application Publication
(10) Pub. No.: US 2017/0085111 A1
(43) Pub. Date: Mar. 23, 2017

(54) APPARATUS FOR DISTRIBUTING VOLTAGE OF LOW DC/DC CONVERTER

(71) Applicants: Hyundai Motor Company, Seoul (KR); Kia Motors Corporation, Seoul (KR)

(72) Inventors: Yu Seok Kim, Seoul (KR); Ji Woong Jang, Hwaseong (KR)

(73) Assignees: KIA MOTORS CORPORATION, Seoul (KR); HYUNDAI MOTOR COMPANY, Seoul (KR)

(21) Appl. No.: 14/943,919

(22) Filed: Nov. 17, 2015

(30) Foreign Application Priority Data
Sep. 23, 2015 (KR) 10-2015-0134473

(51) Int. Cl. H02J 7/00

(52) U.S. Cl. CPC H02J 7/0054; H02J 7/0072; H02J 2007/0059

(57) ABSTRACT

An apparatus for distributing a voltage of a low DC/DC converter that prevents a degradation of a battery and increases the useable life of the battery. Further, a voltage is more stably supplied to the battery and an electric/electronic device by dividing an output voltage from a LDC into a voltage supplied to the battery and a voltage supplied to the electric/electronic device. The apparatus for distributing a voltage of the LDC includes the LDC configured to convert a voltage provided from a first battery, and a distributor configured to divide a voltage provided from the LDC and apply different voltages to an electric/electronic device and a second battery.

### CROSS-REFERENCE TO RELATED APPLICATION

This application is based on and claims the benefit of priority to Korean Patent Application No. 10-2015-0134473, fried on Sep. 23, 2015, in the Korean Intellectual Property Office, the disclosure of which is incorporated herein in its entirety by reference.

### TECHNICAL FIELD

The present disclosure relates to an apparatus for distributing a voltage of a low direct current to direct current converter, and more particularly, to a technique of variably controlling an output voltage of a low direct current to direct current converter based on the load currents.

### BACKGROUND

Engine electric systems (e.g., starting systems, ignition systems, and charging systems) and lighting systems are generally known electric systems of vehicles. Recently, as vehicles have increasingly become controlled by electronic systems, systems including chassis electric systems are electrified and digitalized.

Various electric/electronic devices, such as a lamp, an audio set, a heater, and an air-conditioner, installed within vehicles are configured to receive power from a battery when the vehicle is stopped (e.g., in a static position) and receive power from a generator while the vehicle is being driven (e.g., while translating motion). For example, a power generation capacity of a 14V-based power system is used as a general source voltage. Recent developments of information technology have included various new technologies (e.g., motor type power steering, the Internet, etc.) for increasing convenience of vehicles and have been installed within vehicles. Further, the development of new technologies utilizing the current vehicle systems to the maximum is expected to continue.

Accordingly, due to the increase in electric loads generated by the electric systems for the purpose of performance enhancement, convenience, comfort, and safety of vehicles, 12V batteries have limitations. In other words, existing 14V-based power systems are unable to supply sufficient electric power to vehicles employing new technologies, and power systems supporting supply of a greater amount of electric power is required.

Electric vehicles including such electric systems include, power supplied to electric/electronic devices and batteries. For example, a high voltage is reduced to a low voltage using a direct current to direct current converter (e.g., LDC) and the reduced power is simultaneously supplied to each of the electric/electronic devices and batteries. However, the LDC uniformly adjusts the lowered voltage (e.g., output voltage), the 12V battery voltage is varied according to electric/electronic devices. Since an intended voltage is not maintained, lifespan of a battery may be reduced and the electric/electronic devices may malfunction.

The above information disclosed in this section is intended merely to aid in the understanding of the background of the invention, and therefore may contain information that does not form the prior art that is already known to a person of ordinary skill in the art.

### SUMMARY

An aspect of the present disclosure provides an apparatus for distributing a voltage of a low direct current to direct current (e.g., DC/DC) converter (e.g., LDC), that prevents a degradation of durability of a battery, increases life time of the battery, and supplies a more stable voltage to the battery. Further, the voltage to an electric/electronic device may be divided into an output voltage from an LDC into a voltage supplied to the battery and a voltage supplied to the electric/electronic device.

According to an exemplary embodiment, an apparatus for distributing a voltage of a low DC/DC converter may include an LDC configured to convert a voltage provided from a first battery and a distributor configured to divide a voltage provided from the LDC and apply different (e.g., varying) voltages to an electric/electronic device and a second battery.

The apparatus may further include a transformer configured to generate an output voltage from the LDC, as a voltage having a predetermined level; and a rectifying circuit component configured to rectify the output voltage. The transformer and the rectifying circuit component may be positioned between the LDC and the distributor. The distributor may include a diode and may include a structure in which a diode and a resistor are connected in series. The distributor may be configured to be disposed at a secondary side of the transformer, and may be disposed between the rectifying circuit component and the diode. The distributor may provide a voltage less than the voltage of the electric/electronic device, to the second battery. The rectifying circuit component may include a diode and a capacitor.

The LDC may include a switching component configured to receive a switching signal based on a phase shift control and may form a zero voltage switching (e.g., ZVS) within a leading leg (e.g., LE) and a lagging leg (e.g., LA) during a light load operation. The leading leg and the lagging leg may each include a plurality of switches, and anti-parallel diodes may be connected to the switches. A node disposed between the plurality of switches (e.g., two) of the leading leg and a node disposed between the plurality switches of the lagging leg may be connected to a primary side terminal of the transformer.

### BRIEF DESCRIPTION OF THE DRAWINGS

The above and other objects, features and advantages of the present disclosure will be more apparent from the following detailed description taken in conjunction with the accompanying drawings.

FIG. 1 is an exemplary block diagram illustrating an apparatus for distributing a voltage of LDC according to an exemplary embodiment of the present disclosure;

FIG. 2 is an exemplary circuit diagram illustrating a method for distributing a voltage by an apparatus for distributing a voltage of a LDC according to an exemplary embodiment of the present disclosure; and

FIG. 3 is an exemplary circuit diagram illustrating a method for distributing a voltage by an apparatus for distributing a voltage of a low DC/DC converter (LDC) according to an exemplary embodiment of the present disclosure.

### DETAILED DESCRIPTION

Advantages and features of the present invention, and implementation methods thereof will be described through exemplary embodiments described with reference to the accompanying drawings. The present invention may, however, be embodied in different forms and should not be construed as limited to the exemplary embodiments set forth herein. Rather, these embodiments are provided to describe the present disclosure so that a technical concept of the present invention may be easily practiced by those skilled in the art to which the present invention pertains.

In the drawings, the exemplary embodiments of the present disclosure are not limited to a specific form and are exaggerated for clarity. The specific terms used in the present disclosure are merely used to describe the present disclosure, and are not intended to limit meanings or the scope of the present disclosure described in claims.

The terminology used herein is for the purpose of describing particular embodiments only and is not intended to be limiting of the invention. As used herein, the singular forms “a”, “an” and ^{the} are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although an exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Hereinafter, exemplary embodiments of the present disclosure will be described in detail with reference to the accompanying drawings.

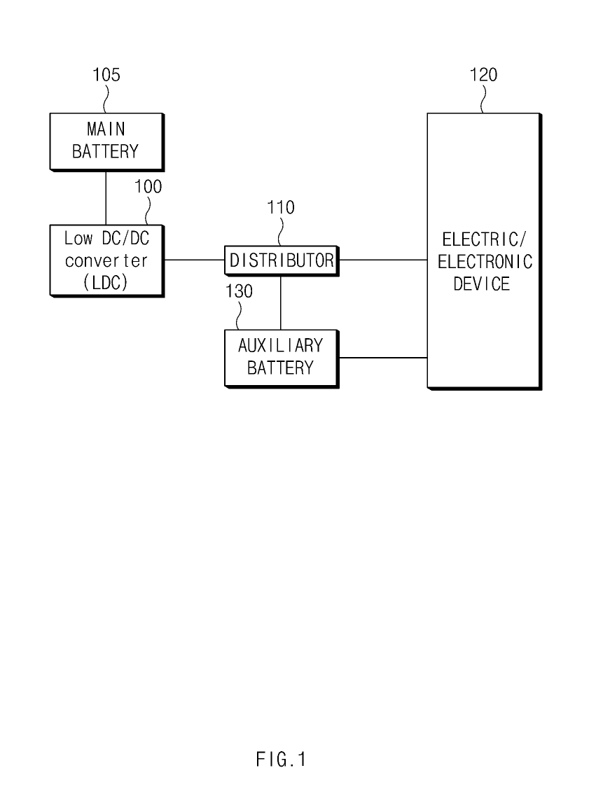

FIG. 1 is an exemplary block diagram illustrating an apparatus for distributing a LDC according to an exemplary embodiment of the present disclosure. Referring to FIG. 1, the apparatus for distributing a voltage of an LDC may include an LDC 100 and a distributor 110. The LDC 100 may be a device configured to convert an alternating current (e.g., AC) voltage provided to a first battery 105 into a direct current (e.g., DC) voltage. For example, the first battery 105 may refer to a high voltage battery or a main battery. In particular, the LDC 100 may include a switching component configured to receive a switching signal based on the control of a phase shift and formation of a zero voltage switching (ZVS) within a leading leg (LE) and a lagging leg (LA) during a light load condition.

The distributor 110 may be configured to apply different (e.g., varying) power voltage to an electric/electronic device 120 and a second battery 130. In other words, about 14.8V may be applied to the electric/electronic device 120, and about 13.2V may be applied to the second battery 130. In particular, about 14.8V may be reduced to about 13.2V via a diode and may be applied. For example, the second battery 130 may refer to a low voltage battery or an auxiliary battery. The distributor 110 may include a structure having a diode or a structure that has the diode and a resistor connected in series.

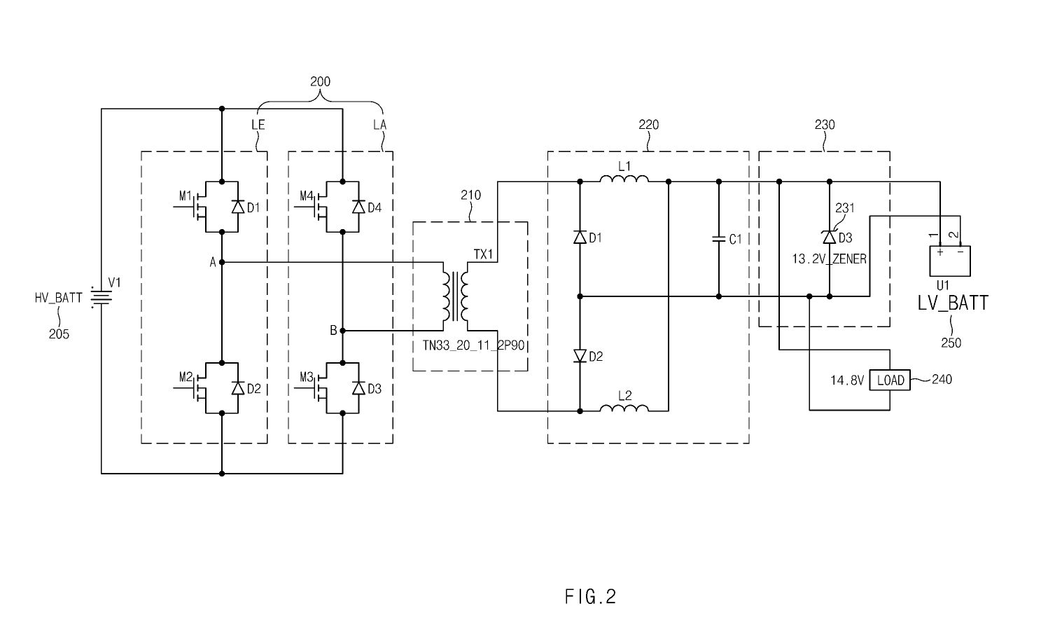

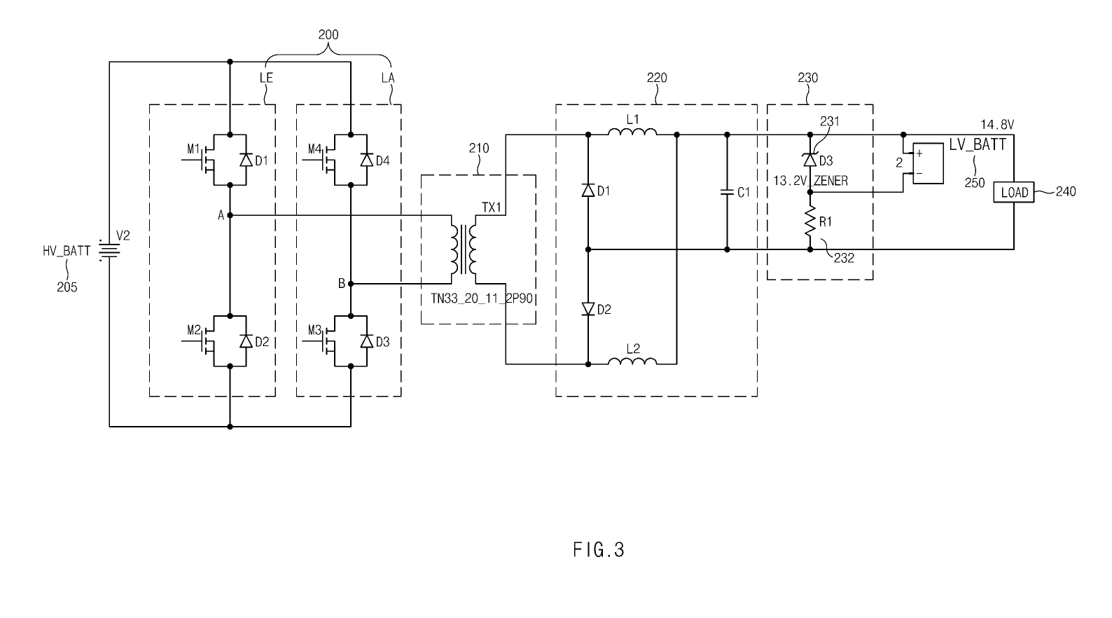

FIGS. 2 and 3 are exemplary circuit diagrams illustrating a method for distributing a voltage by an apparatus for distributing a voltage of a low DC/DC converter (LDC) according to an exemplary embodiment of the present disclosure. Referring to FIGS. 2 and 3, an LDC 200 may be a device configured to convert an alternating current (e.g., AC) voltage provided from a first battery 205 into a DC voltage. In particular, the LDC 200 may include a switching component configured to receive a switching signal based on the phase shift control and may form ZVS within a leading leg (LE) and a lagging lag (LA) during light load conditions. The switching component may include an LE and an LA that may include a plurality of switches. The LE and the LA may be positioned opposite to each other to produce a complementary relation. Additionally, the switching component may be configured to alternately switch an input voltage to convert the voltage and transmit the converted voltage to a transformer 210.

The LE and the LA may include a plurality of switches M1 and M2 and M3 and M4, respectively, and anti-parallel diodes D1, D2, D3, and D4 may be connected to the switches M1, M2, M3, and M4, respectively. A node A may be disposed between the plurality of switches M1 and M2 of the LE and a node B may be disposed between the plurality of switches M3 and M4 of the LA are connected to the primary side terminal of the transformer 210. For example, in the switching component, the LE and the LA may have a predetermined duty ratio, preferably, a duty ratio of about 50%, and may be complementarily operated. The output of the switching component may be based on the phase shift control between the LE and the LA.

The transformer 210 may be configured to generate an output voltage from the switching component, as a voltage that may have a predetermined level. A rectifying circuit component 220 may be connected to the diodes D1 and D2 disposed within a secondary side of the transformer 210. For example, the rectifying circuit component 220 may be configured to rectify an AC voltage that converts the frequency characteristics to a DC voltage, and the rectified DC voltage may be filtered by a capacitor C1.

A distributor 230 may be configured to apply different power to an electric/electronic device 240 and a second battery 250. In other words, about 14.8V may be applied to the electric/electronic device 240, and about 13.2V may be applied to the second battery 250, and, about 14.8V may be reduced via the diode 231 to about 13.2V and then may be applied. The distributor 230 may include a structure having a diode 231 or D3 or a structure in which the diode 231 or D3 and a resistor 232 or R1 are connected in series. For example, the resistor 232 may be connected to the diode 231 in series, and when the diode 231 lowers a voltage, the resistor 232 may divide the voltage more stably.

As described above, according to the exemplary embodiments of the present disclosure, a degradation of durability due to an electrolyte decomposition of a battery and collapse of a cathode or an anode of the battery may be prevented. Additionally, the LDC may be configured to supply required voltages to the battery and the electric/electronic device. Further, a high voltage may be precluded from being supplied to the second battery, reducing heating of the second battery and enhancing a lifespan of the second battery. Conversely, a high voltage may be applied to the electric/electronic device.

While this invention has been described in connection with what is presently considered to be practical exemplary embodiments and the accompanying drawings, the present disclosure is not limited to the disclosed exemplary embodiments, but on the contrary, is intended to cover various modifications and equivalent arrangements included, within the spirit and scope of the present disclosure claimed in the following claims.

What is claimed is:

1. An apparatus for distributing a voltage of a low direct current to direct current converter (LDC), the comprising:
an LDC configured to convert a voltage provided from a first battery; and
a distributor configured to divide a voltage provided from the LDC and apply different voltages to an electric/electronic device and a second battery.

2. The apparatus according to claim 1, further comprising:
a transformer configured to output an output voltage from the LDC, as a voltage having a predetermined level; and
a rectifying circuit component configured to rectify the output voltage,
wherein the transformer and the rectifying circuit component are positioned between the LDC and the distributor.

3. The apparatus according to claim 1, wherein the distributor includes a diode.

4. The apparatus according to claim 1, wherein the distributor includes a structure that has a diode and a resistor connected in series.

5. The apparatus according to claim 1, wherein the distributor is disposed at a secondary side of a transformer, and is disposed between a rectifying circuit component and a diode.

6. The apparatus according to claim 1, wherein the distributor is configured to provide a voltage less than that of the electric/electronic device, to the second battery.

7. The apparatus according to claim 5, wherein the rectifying circuit component includes the diode and a capacitor.

8. The apparatus according to claim 1, wherein the LDC includes a switching component configured to receive a switching signal based on a phase shift control and form a zero voltage switching in a leading leg and a lagging leg in the event of a light load.

9. The apparatus according to claim 8, wherein the leading leg and the lagging leg h include two switches, and anti-parallel diodes are respectively connected to the switches.

10. The apparatus according to claim 8, wherein a node between two switches of the leading leg, and a node between two switches of the lagging leg are connected to a primary side terminal of a transformer.
